(19) United States
(12) Patent Application Publication
(10) Pub. No.: US 2010/0056127 A1
(43) Pub. Date: Mar. 4, 2010

(54) System and Method for Application Layer Widgets for Mobile Devices

(76) Inventors: John Osborne, Incline Village, NV (US); James H. Schmidt, Incline Village, NV (US)

Correspondence Address: IAN F. BURNS & ASSOCIATES, 4790 Caughlin Parkway #701, RENO, NV, 89519-0907, US

(21) Appl. No.: 12/547,854

(22) Filed: Aug. 26, 2009

Related U.S. Application Data
(60) Provisional application No. 61/092,296, filed on Aug. 27, 2008.

(51) Int. Cl. H04M 3/00

(52) U.S. Cl. 455/418

(57) ABSTRACT

A communication system includes a wireless device and a computer server that is in communication with the wireless device. The computer server is adapted to receive at least one parameter associated with the wireless device and to select at least one widget that is optimized to be run on the wireless device. The widget is transmitted to the wireless device. A method of selecting a widget that is best suited for a mobile device platform is also disclosed.

### CROSS REFERENCE TO RELATED APPLICATIONS

This application claims priority to U.S. provisional patent application Ser. No. 61/092,269, filed Aug. 27, 2008. The entire contents of which are herein incorporated by reference.

### FIELD OF THE INVENTION

The present invention relates to data processing and wireless communication systems. More specifically, the present invention relates to systems and methods for the transmission of software applications and widgets to mobile wireless devices.

### BACKGROUND

Wireless communication devices such as cell phones were originally designed primarily to handle analog voice communications. Since then, additional demands for the transmission and reception of digital data have been placed on wireless networks. For example, digital data such as short message service (SMS), multimedia message service (MMS), application middleware, and World Wide Web browsers have steadily increased the role and demand of digital data in mobile devices. Mobile device platforms can use an Internet browser to be able to load HTML, XHTML and Java applications called widgets, to perform additional functions and tasks. This capability, however, has been lacking at the platform application level.

While most Internet browsers on various network platforms have some form of XHTML or widget support, mobile wireless communication devices have lacked such services and support at the application level due to limited processing power and memory space, and the lack of any cohesive standard.

### SUMMARY OF ONE EMBODIMENT OF THE INVENTION

### Brief Description of One Embodiment of the Present Invention

In one embodiment, the present invention comprises a communication system that includes a wireless device and a computer server that is in communication with the wireless device. The computer server is adapted to receive at least one parameter associated with the wireless device and to select at least one widget that is optimized to be run on the wireless device. The widget is transmitted to the wireless device.

In another embodiment, the present invention comprises a computerized method. The method includes receiving at least one parameter associated with a wireless device and selecting at least one widget that is optimized to be run on the wireless device. The widget is transmitted to the wireless device.

In an additional embodiment, the present invention comprises a machine-readable medium comprising instructions, which when implemented by a computer performs the following operations: At least one parameter is received that is associated with a wireless device; At least one widget is selected from a database of widgets; The selected widget is configured to be run on the wireless device; and The widget is transmitted to the wireless device.

In yet another embodiment, the present invention comprises a communication system. The communication system includes a wireless device and a computer server in communication with the wireless device. The computer server has a processor. Software is operable on the processor to receive at least one parameter associated with the wireless device and to determine at least one widget that is optimized to be run on the wireless device. The widget is transmitted to the wireless device.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### ADVANTAGES OF ONE OR MORE EMBODIMENTS OF THE PRESENT INVENTION

The various embodiments of the present invention may, but do not necessarily, achieve one or more of the following advantages:

The ability to send a request from a wireless device that contains device capabilities and parameters associated with the wireless device;

The ability to select at least one widget that is optimized to be run on a wireless device.

The ability to transmit a widget to a wireless device;

Provide a widget database that contains a plurality of widget versions, each of the widget versions associated with at least one wireless device parameter;

The ability to modify a widget or a software program to best match the capabilities of a mobile communication device;

The ability to determine if a widget should be modified;

The ability to select and optimize a widget for an application;

The ability to transmit wireless device capabilities when a reference tag is encountered by a running software program;

Provide a widget database that contains widget versions that match wireless device parameters and capabilities such as screen size, screen orientation, screen resolution, screen color depth, display capabilities, audio capabilities and memory size; and

These and other advantages may be realized by reference to the remaining portions of the specification, claims, and abstract.

### BRIEF DESCRIPTION OF THE DRAWINGS

FIG. 1 is substantially a diagrammatic view of a wireless communication network in accordance with the present invention.

FIG. 2 is substantially a diagrammatic view of a computer server.

FIG. 3 is substantially a diagrammatic view of a wireless communication device.

FIG. 4 is substantially a flowchart of a method for determining, selecting and transmitting an application widget in accordance with the present invention.

FIG. 5 is substantially an example of a selection and optimization process of an application widget in accordance with the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

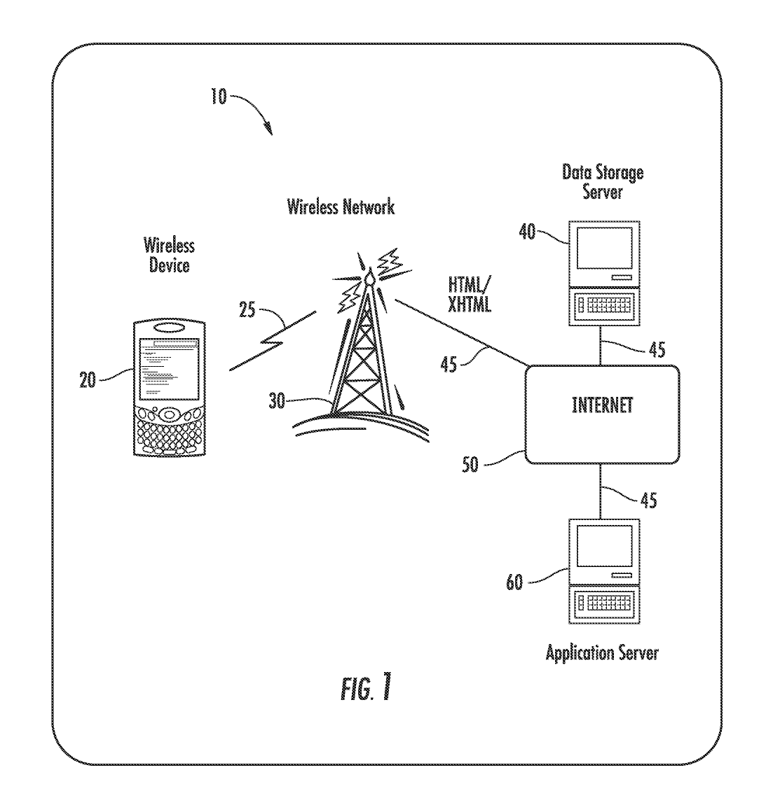

Referring to FIG. 1, a communication system 10 is shown. Communication system 10 can include a mobile or wireless communication device 20, a wireless network 30, a data storage server 40, a hardwired network 45, an internet connection 50 and an application server 60.

Mobile communication device 20 can be a wide variety of wireless communication devices such as personal data assistants, mobile telephones, laptop computers, pagers, email devices and netbooks. Wireless network 30 can be in communication with mobile communication device 20 through a wireless signal 25. Wireless network 30 can send and receive wireless signals 25. Wireless network 30 can use a wide variety of communication protocols and systems and can include, but is not limited to PCS, GSM, TDMA, CDMA, Internet Protocol (IP) network, Wireless Application Protocol (WAP) network, a WiFi network, bluetooth or a local area network (LAN).

Wireless network 30 can be in communication with an internet connection 50 through a hardwired network 45. Hardwired network 45 can include a wide variety of hardwired communication devices and transmission mediums such as metal or optical cables and other terrestrial based communication systems. Internet connection 50 can be in communication with a data storage server 40 and an application server 60 through hardwired network 45. Internet connection 50 may in itself be a computer server running on a network. In an embodiment, wireless network 30 may be in direct communication with either data storage server 40 or application server 60.

Data storage server 40 can store, send and receive a wide variety of data, software programs, applications and communications that can be routed from data storage server 40 to wireless network 30 through internet connection 50.

Internet connection 50 can cause application programs and data to be routed from application server 60 and data storage server 40 to wireless network 30.

Application server 60 can contain a wide variety of applications, software programs and instructions that can be executed, downloaded or run on wireless device 20. For example, widgets, applets, internet programs or messaging programs and data may be transmitted from application server 60 to wireless device 20. Wireless device 20 may also request, send and receive data and programs from application server 60.

A widget is defined as an application or program that can be run on wireless device 20 that may or may not use data streamed or transmitted from a network resource. The widget may be embedded within a web page using Hypertext Markup Language (HTML), Extensible Hypertext Markup Language (XHTML), Java or other programming languages. A widget typically adds content to an application or web page that is not static. Widgets are downloadable application programs that can be implemented using internet technologies.

Through internet connection 50, the application or widget receives script pages or other descriptions of content to be rendered to wireless device display for the purposes of user interaction or the delivery of content. One or more of these pages may contain an application identification tag that references an HTML, XHTML, Java or other runtime object that requires execution.

In one embodiment, wireless network 30, data storage server 40 and application server 60 may exist entirely within a single device, where minimizing transmission overhead and data packets would be advantageous between the various subsystems.

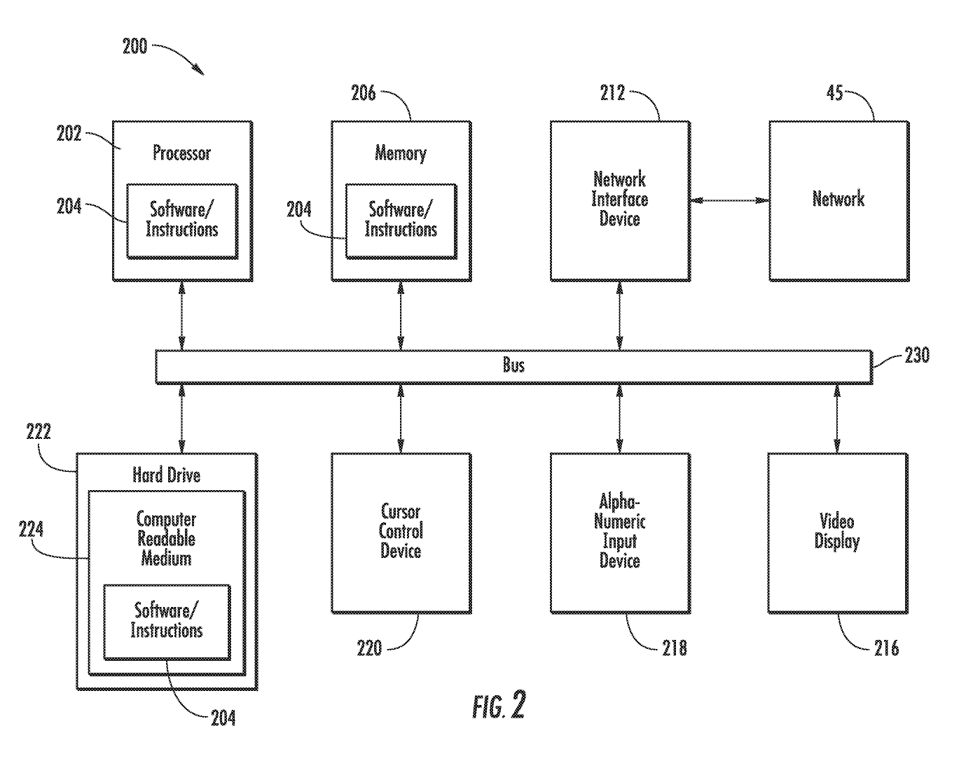

With reference to FIG. 2, a block diagram of a computer server 200 such as data storage server 40 (FIG. 1) or application server 60 (FIG. 1) is shown. Computer server 200 may execute a set of instructions or software programs that cause any one or more of the methods, processes, operations, applications, or methodologies discussed herein to be performed.

In a networked embodiment, computer server 200 may operate in a server-client network environment, or as a peer machine in a peer-to-peer (or distributed) network environment.

Computer server 200 can include a processor or central processing unit 202 and a main memory 206, which communicate with each other via a bus 230. The computer server 200 further includes a video display 216, an alphanumeric input device 218, a cursor control device 220 such as a mouse, a hard drive unit 222 and a network interface device 212.

The drive unit 222 includes a machine-readable medium 224 on which is stored one or more sets of instructions such as software programs 204 that include any one or more of the methodologies or functions described herein. The software 204 may also reside, completely or at least partially, within the main memory 206 and/or within the processor 202 during execution thereof by the computer server 200. The main memory 206 and the processor 202 also comprise machine-readable media. The software 204 may include data objects and applications that can be transmitted or received over network 45 via the network interface device 212.

While the machine-readable medium 224 is shown in an example embodiment to be a single medium, the term, “machine-readable medium”, should be taken to include a single medium or multiple medium such as a centralized or distributed database, and/or associated caches and servers that store one or more sets of instructions. The term, “machine-readable medium”, shall also be taken to include any medium that is capable of storing, encoding or carrying a set of instructions for execution by the machine and that cause the machine to perform any one or more of the methodologies shown in the various embodiments of the present invention. The term, “machine-readable medium”, shall accordingly be taken to include, but not be limited to, solid-state memories, optical and magnetic media, and carrier wave signals.

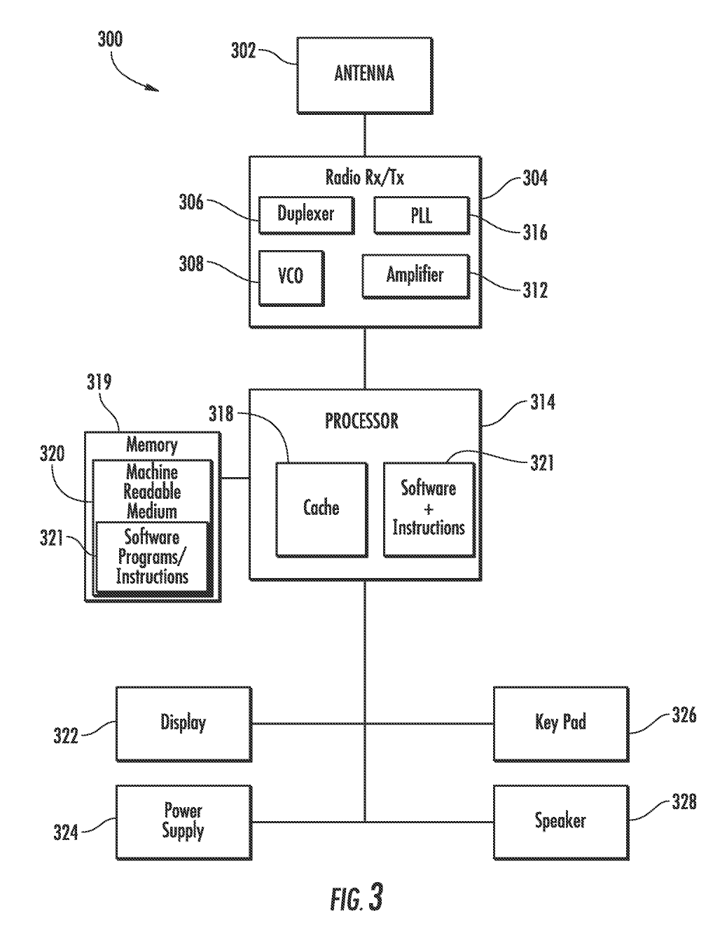

Turning now to FIG. 3, a diagrammatic view of a wireless communication device 300 such as wireless device 20 of FIG. 1 is shown. An example of a mobile device for use with the methods and systems described herein is a self-powered wireless device capable of a wide-area or local wireless communication with a plurality of other of hand-held, mobile, self-powered wireless devices or with communication networks such as base stations that are at a fixed location. The hand-held, mobile, self-powered wireless device can contain a memory, a human input device, a display and a processor. The memory can store a plurality of data relating to applications, data objects and other data.

Communication device 300 can comprise an antenna 302, a radio section 304, a processor 314 and a memory 320. Radio section 304 includes a duplexer 306, voltage controlled oscillator (VCO) 308, phase lock loop circuit (PLL) 310 and an amplifier 312. Duplexer 306 is in communication with antenna 302. Duplexer 306, VCO 308, PLL 310 and an amplifier 312 are in communication with each other. Radio section 304 can transmit and receive RF signals that contain data objects and applications through antenna 302. Any signals received by antenna 302 are processed by radio 304. The processing may include amplification and filtering of the radio frequency signals and analog to digital conversion of any data and information received.

Radio section 304 is in communication with processor 314. Processor 314 can include a memory cache 318 for the storage of frequently used data and software and instructions 321 that may reside in processor 314 for execution on processor 314. Memory 319 is in communication with processor 314. Memory 319 can be a wide variety of memory devices such as flash memory, RAM, ROM or EPROM memory devices.

Memory 319 may include a machine-readable medium 320 on which is stored one or more sets of instructions such as software programs 321 that include any one or more of the methodologies or functions described herein. The software 321 may also reside, completely or at least partially, within the cache 318 and/or within the processor 314 during execution thereof. The software 321 may include data objects and applications that can be transmitted or received with data storage server 40 (FIG. 1) over the wireless network 30 (FIG. 1).

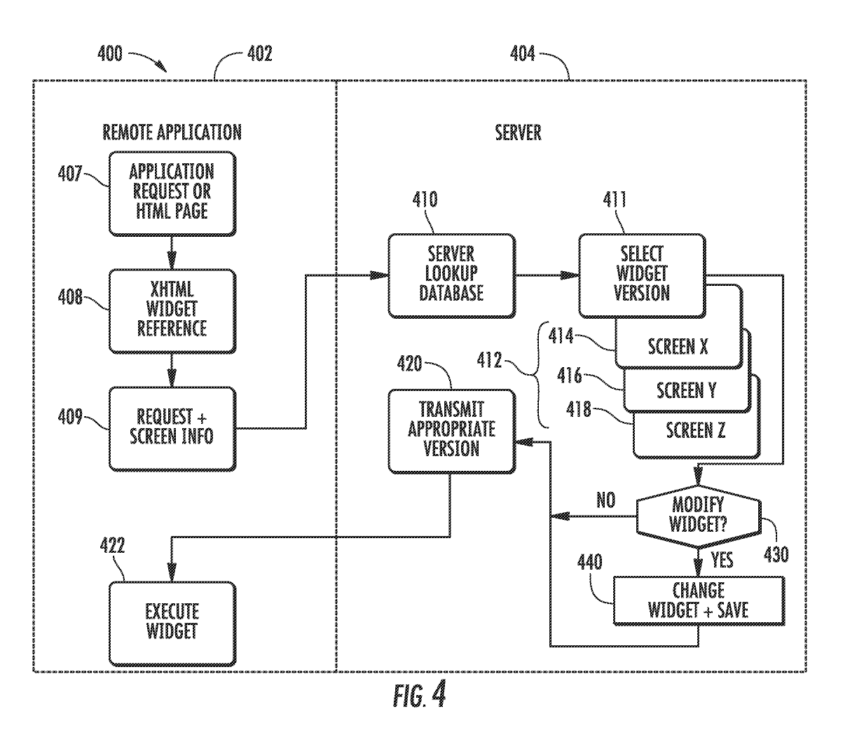

Communication device 300 may further comprise a display 322 such as an LCD display, a keypad 326 for inputting commands and information, a speaker 328 and a power supply 324. Turning now to FIG. 4, a flowchart of a method 400 for determining, selecting and transmitting an application widget is shown. At least a portion of method 400 can be programmed as software 204 stored in memory 206 or drive unit 222 and run on processor 202 of computer server 200 (FIG. 2). Another portion of method 500 can be programmed as software 321 stored in memory 319 and run on processor 314 of wireless communication device 300 (FIG. 3).

Method 400 is part of a dynamic real time optimization routine to optimize widgets running on mobile devices by matching the mobile device settings and capabilities with a version of the application software or widget that maximizes functionality of the widget on the wireless device. Method 400 can evaluate the capabilities of the wireless device and select a version of the widget or application software that best matches the operating parameters of the wireless device. Method 500 may perform some or all of the following steps in an order which may not be in the order listed.

In FIG. 4, the procedures, routines or steps of method 400 are divided into two portions.

Steps 402 can be executed on a wireless communication device 20 (FIG. 1) or 300 (FIG. 3).

Steps 404 can be executed on computer server 40 or 60 (FIG. 1) or 300 (FIG. 3).

An application, script or web page is running or about to be run on a wireless communication device 20 (FIG. 1) in step 407. At step 408, the software application or script can encounter a reference tag to a widget or software program. The reference tag may be an XHTML widget reference. The widget or software program may be stored on an external source such as data server 40 (FIG. 1) or application server 60 (FIG. 1).

Next, method 400 communicates with an appropriate server in the network and transmits the request for the widget or widget script in step 409. The widget request can contain an identifier for the widget. The widget request in step 409 also can contain information about capabilities, parameters and settings of the mobile communication device such as, but not limited, to screen size, screen orientation, screen resolution, screen color depth, display capabilities, audio capabilities memory size and other resources resident on the communication device and available to the application. The parameters of the wireless device are sent to the computer server. When a reference tag is reached by a program running on the wireless device, device capability and parameters are transmitted along with the widget request to the computer server. At step 410, the computer server retrieves a database of widget versions 412 associated with the widget identifier.

The database of widget versions or widget database 412 can contain a wide variety of versions or permutations of the widget. In an embodiment, the widget database 412 may contain a specific widget for each parameter or setting that is unique to the specific wireless device that is being used. For example, in one embodiment, the widget database 412 can contain a widget 414 for a display screen size X, a widget 416 for a display screen size Y and a widget 418 for a display screen size Z. Other widget versions may be provided in widget database 412 that are tailored for other specific parameters of the wireless device in order to optimize the performance of the widget script running or executing on the wireless device. For example, widgets may be provided in widget database 412 that are specifically optimized for display color or audio capabilities.

At step 411, the computer server determines or selects the best widget version to optimize the performance of the widget on the wireless device. The computer server can select the best or most appropriate widget that is coded to match or nearly match the device parameters associated with the mobile communication device. The computer server may run a software program or routine to determine the most appropriate widget version to select from the widget database 412. The computer server may select the proper widget definition from a predefined list or database of widget versions that match the widget's processing requirements against the capability of the wireless device. In an embodiment, step 411 may select widget version 416 for a display screen size Y as being the best widget to run on the wireless device.

After the best widget version has been selected in step 411, method 400 proceeds to decision step 430. At decision step 430, method 400 determines if the selected widget requires modification to more closely match the device parameters associated with the mobile communication device. The computer server may be programmed to make parametric changes to the widget itself to alter its script before transmission to the wireless device.

If the selected widget requires modification, method 400 proceeds to step 440. If the selected widget does not require modification, method 400 proceeds to step 420. At step 440, the widget or software is modified to more closely match the device parameters associated with the mobile communication device. For example, in one embodiment, if the proper screen size is not available from the widget database 412, the widget with the closest screen size can be modified in step 440 to the required screen size. In an embodiment, the computer server may modify a generic application widget script in a predefined matter. In another embodiment, the computer server may modify a generic application widget script to match the widget's processing requirements against the capability of the wireless device.

Other widget features may also be modified to match the parameters of the wireless device such as graphics, animations, audio, or video. The modified widget may then be saved on the computer server in widget database 412 for future use and retrieval.

After the appropriate widget has been selected in step 411 and/or the changes have been made to the widget in step 440, the widget is transmitted to the mobile wireless device in step 420. The widget may then be executed on the wireless device in step 422.

In one embodiment, the widget may be permanently stored on the wireless device, and made available to the user through the application interface, or run in as a background program on the wireless device as a permanent addition to the unit's functionality.

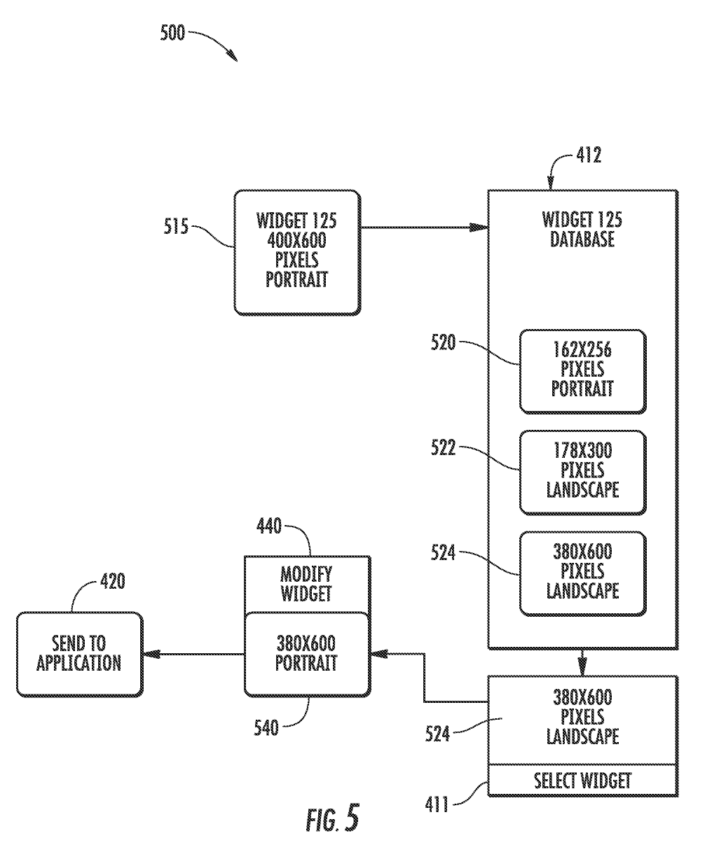

With reference to FIGS. 4 and 5, an example selection and optimization process 500 of an application widget using method 400 of FIG. 4 is shown. A wireless device can transmit in step 409 a server request containing a widget identifier and wireless device parameters 515 such as a display or screen resolution of 400×600 pixels and the screen is in portrait orientation. The request contains a widget identifier such as “Widget 125”. The computer server in step 410 uses the widget identifier to address and locate the collection of widget or widgets database 412 relating to or associated with the widget identifier. Under the widget database 412, any number of specific widgets may be predefined.

From the widgets in the widget database, the computer server selects the one which most closely resembles the widget parameters as transmitted by the wireless device in step 411. In FIG. 5, widget database 412 contains three widget versions. Widget 520 is a 162×256 pixel widget in portrait orientation. Widget 522 is a 178×300 pixel widget in landscape orientation. Widget 524 is a 380×600 pixel widget in landscape orientation. From the widget database, widget 524 can be selected as the best fit or most closely matching the widget parameters in step 411.

It is noted that some of the parameters may not match in the best widget selection. For example, in the selected widget 524, the display orientation of landscape does not match the display orientation of portrait in the transmitted request 515.

After selection of the optimized widget, at least one of the remaining unmatched parameters may allow modification or parametric substitution in step 440. If this ability is specified in the widget, the computer server can then proceed with the modification. In FIG. 5, step 440 modifies widget 524 from a display of 380×600 pixels with landscape orientation to a widget 540 with a display of 380×600 pixels with portrait orientation. The widget display orientation has been modified from landscape to portrait. The optimized widget 540 can then be transmitted to the mobile wireless device in step 420 for execution. The resulting customized widget is the best available widget for the originating wireless device.

The present invention has several advantages. The present invention uses the computer server to select the best application widget version that is best suited to the parameters of the wireless device. The computer server then alters the script accordingly and transmits the widget definition to the wireless device. This places the majority of the processing overhead at the computer server end where computing resources are abundant resulting in saving valuable memory space and operation cycles in the limited capabilities of the wireless device.

The present invention provides a method whereby an application platform is installed on a mobile device. This platform can support various programming languages such as XHTML, CSS2, Java Script, and other custom or standardized scripts that define the execution of a software application control or widget. The computer server which is hosting the platform contains a database of the variations of screen size and orientation that could be present in the client wireless device.

The present invention can provide generic HTML/XHTML support to any mobile network, providing access to back end services such as but not limited to SMS, MMS, provisioning, billing, PSMS, PMMS, mobile e-commerce, error handling, mobile advertisements, and other 3^{rd} party systems and feeds running at the application layer, not within a separate browser. The present invention provides a generic application layer XHTML/Widget support system for mobile devices that can handle the variations needed for adaptive screen sizes and resource allocation needs in various device platforms.

In another embodiment, the present invention provides a system and method for application layer widgets on mobile devices whereby an application running on a mobile platform connects to a transmission service to request an application widget from an external computer server. The mobile device platform's screen size and orientation are transmitted to the computer server with the request. The computer server then modifies the generic application widget script in a predefined matter and transmits the widget to the device for execution.

In an additional embodiment, the present invention can provide a system and method wherein a mobile device platform's screen size, orientation, and optionally its available services are transmitted to the computer server with a widget request. The computer server may modify the generic application widget script to match the widget's processing requirements against the capability of the wireless device platform. The modified widget can be sent or transmitted to the wireless device for execution.

In an embodiment, the present invention can provide a method where the mobile device platform's screen size, orientation, and optionally its available services are transmitted to the computer server with a widget request. The computer server may select the proper widget definition from a predefined list or database of widget versions that match the widget's processing requirements against the capability of the wireless device. The best or optimized widget then can be transmitted to the wireless device for execution.

In one more embodiment of the present invention, the computer server may perform additional processing step such as the conversion of animations or graphics into different or more suitable formats that match the capabilities of the requesting mobile device.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

We claim:

1. A communication system comprising:
(A) a wireless device;
(B) a computer server in communication with the wireless device, the computer server being adapted to:
(a) receive at least one parameter associated with the wireless device;
(b) select at least one widget that is optimized to be run on the wireless device; and
(c) transmit the widget to the wireless device.

2. The communication system of claim 1, wherein the widget is optimized for the parameter.

3. The communication system of claim 1, further comprising determining if the selected widget requires modification.

4. The communication system of claim 1, further comprising modifying the selected widget.

5. The communication system of claim 1, wherein the computer server contains a database of widgets.

6. A computerized method, not necessarily in the order shown comprising:
(A) receiving at least one parameter associated with a wireless device;
(B) selecting at least one widget that is optimized to be run on the wireless device; and
(C) transmitting the widget to the wireless device.

7. The method of claim 6, wherein the widget is optimized for the parameter.

8. The method of claim 6, further comprising determining if the selected widget requires modification.

9. The method of claim 6, further comprising modifying the selected widget.

10. The method of claim 6, further comprising executing the selected widget.

11. A machine-readable medium comprising instructions, which when implemented by a computer performs the following operations:
(A) receive at least one parameter associated with a wireless device;
(B) select at least one widget from a database of widgets, the selected widget configured to be run on the wireless device; and
(C) transmit the widget to the wireless device.

12. The machine readable medium of claim 11, wherein the widget is optimized for the parameter of the wireless device.

13. The machine readable medium of claim 11, further comprising determining if the selected widget requires modification.

14. The machine readable medium of claim 11, further comprising modifying the selected widget.

15. The machine readable medium of claim 11, further comprising executing the selected widget.

16. A communication system comprising:
(A) a wireless device;
(B) a computer server in communication with the wireless device, the computer server having a processor;
(C) software operable on the processor to:
(a) receive at least one parameter associated with the wireless device;
(b) determine at least one widget that is optimized to be run on the wireless device; and
(c) transmit the widget to the wireless device.

17. The communication system of claim 16, wherein the widget is selected based on best matching the parameter.

18. The communication system of claim 16, further comprising determining if the selected widget requires modification.

19. The communication system of claim 16, further comprising modifying the selected widget.

20. The communication system of claim 16, further comprising comparing the parameter to a database of parameters associated with a plurality of widgets versions.
